(19) United States
(12) Patent Application Publication
(10) Pub. No.: US 2024/0264942 A1
(43) Pub. Date: Aug. 8, 2024

(54) CO-COMPUTE UNIT IN LOWER-LEVEL CACHE ARCHITECTURE

(71) Applicant: ADVANCED MICRO DEVICES, INC., Santa Clara, CA (US)

(72) Inventors: DaZheng Wang, Shanghai (CN); Jie Zhang, Orlando, FL (US); Zhenyu Xu, Oviedo, FL (US)

(21) Appl. No.: 18/106,747

(22) Filed: Feb. 7, 2023

(51) Int. Cl. G06F 12/0811; G06F 12/0897

(52) U.S. Cl. CPC G06F 12/0811; G06F 12/0897

(57) ABSTRACT

A processor includes compute units each including a first-level cache and each communicatively coupled to a co-compute unit (CCU) within a lower-level cache. In response to a compute unit receiving instructions to perform operations for an application, the compute unit determines one or more parameters based on the received instructions. The compute unit then sends the parameters and instructions to perform one or more operations on behalf of the compute unit to a respective CCU. The CCU then performs the operations based on the parameters and using the lower-level cache. Once the CCU has performed the operations, the CCU then sends the results of the operations back to the compute unit.

### BACKGROUND

When running an application, processing systems include processors with compute units configured to perform operations, such as data computations, for the application. To help perform these operations, each compute unit is communicatively coupled to a first-level cache and is configured to store values, operands, and data used to perform the operations in the first-level cache. However, for many memory-intensive applications, such as raytracing applications and machine-learning applications, the amount of data needed to perform operations exceeds the size of the first-level caches, resulting in an undesirably high amount of activity at the first-level caches (e.g., because data is repeatedly loaded to and evicted from the first-level cache). This high level of cache activity increases processing times and decreases the efficiency of the processing system.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system implementing one or more co-compute units in a lower-level cache, in accordance with some embodiments.

FIG. 2 is a diagram of an example architecture of processing system using co-compute units within a lower-level cache, in accordance with some embodiments.

FIG. 3 a signal diagram of an example operation for one or more co-compute units performing operations on behalf of a compute unit, in accordance with some embodiments.

FIG. 4 is a diagram of an example architecture of a processing system using a virtual co-compute unit within a lower-level cache, in accordance with some embodiments.

FIG. 5 is an example timing diagram for performing one or more operations by a co-compute unit on behalf of a compute unit, in accordance with some embodiments.

FIG. 6 is a flow diagram of an example method for a co-compute unit in a lower-level cache performing one or more operations on behalf of a compute unit, in accordance with some embodiments.

FIG. 7 is flow diagram of an example method for a virtual co-compute unit in a lower-level cache performing one or more operations on behalf of a compute unit, in accordance with some embodiments.

### DETAILED DESCRIPTION

In a processing system, processors include compute units configured to perform operations (e.g., data computation operations) for one or more applications running on the processing system. To help perform these operations, each compute unit includes one or more single instruction, multiple data (SIMD) units configured to perform the operations and each compute unit further includes or is otherwise connected to a first-level cache. Such a first-level cache, for example, is within a cache hierarchy arranged by size, with the first-level cache (e.g., top-level cache) being smallest in size and one or more lower-level caches being larger is size. When performing the operations, each compute unit uses a respective first-level cache to store data necessary for, aiding in, or helpful for performing the operations. For example, each compute unit stores data (e.g., instructions, operands, values, operation results) necessary for performing one or more operations of an application. However, operations for memory-intensive applications, for example, raytracing applications, machine-learning applications, or both, require an amount of data that exceeds the size of the first-level caches. That is to say, the total amount of data necessary for, aiding in, or helpful for performing operations for memory-intensive application exceeds the size of the first-level caches, such that all of the necessary data cannot be stored in the first-level cache at the same time. Executing the operations therefore requires data to be loaded to and evicted from the first-level cache at a relatively high rate, and the compute units therefore fail to progress the operations efficiently. Such a scenario is also referred to herein as cache thrashing.

As such, systems and techniques disclosed herein are directed to performing operations for memory-intensive applications without causing cache-thrashing. To this end, a processing system includes a processor including one or more compute units each including or otherwise connected to a first-level cache. Such first-level caches are part of a cache hierarchy arranged by size with the first-level caches being the smallest caches in the cache hierarchy and the lower-level caches being larger in size than the first-level caches. Each compute unit of the processor is communicatively coupled to a co-compute unit (CCU) located within or otherwise connected to a lower-level cache (e.g., a third-level cache) of the cache hierarchy. That is to say, each compute unit is communicatively coupled to a CCU within or otherwise connected to a cache (e.g., a lower-level cache in a cache hierarchy) that is larger than the first-level cache. The CCUs each include, for example, one or more SIMDs configured to perform one or more operations for an application (e.g., a memory-intensive application) on behalf on a respective compute unit. To have a CCU perform one or more operations for an application (e.g., a memory-intensive application) on behalf on a respective compute unit, each compute unit is first configured to receive one or more instructions indicating one or more operations from an application. In response to receiving the instructions, the compute unit determines one or more parameters based on the received instructions. For example, the compute unit performs one or more operations indicated in the instructions to determine the parameters, identifies one or more parameters from the instructions, or both. Such parameters include data defining one or more values necessary for, aiding in, or helpful for performing one or more operations, for example, required register files for an operation, memory requirements for an operation (e.g., the size of the data needed to perform the operation), default values for variables, formats for values (e.g., floating point format, integral format, pointer format), scalar parameters, vector parameters, or any combination thereof. The compute unit then sends the parameters, instructions to perform one or more operations on behalf of the compute unit, or both to a respective CCU (e.g., the CCU communicatively coupled to the compute unit). In response to receiving the parameters, instructions, or both, the CCU performs one or more operations on behalf of the compute unit based on the parameters using the lower-level cache. For example, the CCU establishes vector registers, scalar registers, or both in the lower-level cache that each store data (e.g., register files, operands) used to perform the operations. As another example, the CCU uses the lower level-cache to store data (e.g., instructions, operation results, values, operands) necessary for, aiding in, or helpful for performing the one or more operations. After performing the operations, the CCU then sends the results (e.g., data resulting from the performance of the operations) back to the compute unit, makes the results available (e.g., in a data buffer) to the compute unit, or both. Because the CCUs use a lower-level cache (e.g., larger cache) to perform the operations of memory-intensive applications on behalf of a respective compute unit, the likelihood that cache-thrashing occurs is reduced as the lower-level cache is large enough to store the data necessary for, aiding in, or helpful for performing these operations. As the likelihood for cache-thrashing is reduced, the likelihood of the CCUs stalling or failing to progress when performing the operations is reduced, increasing the processing speed and processing efficiency of the processing system.

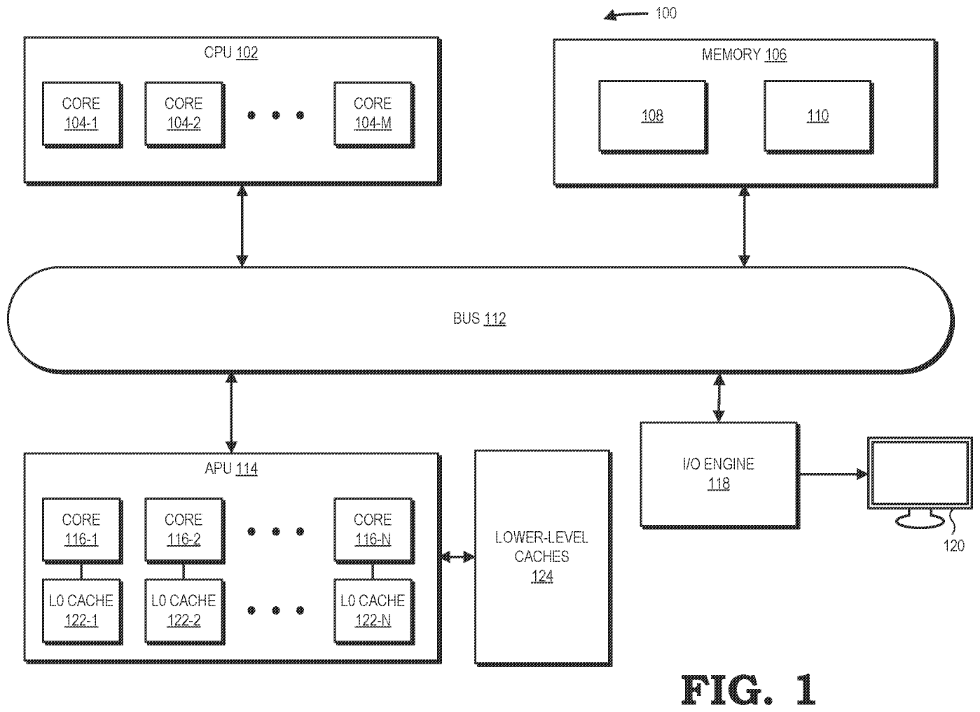

FIG. 1 is a block diagram of a processing system 100 implementing one or more co-compute units in a lower-level cache, according to some embodiments. The processing system 100 includes or has access to a memory 106 or other storage component implemented using a non-transitory computer-readable medium, for example, a dynamic random-access memory (DRAM). However, in embodiments, the memory 106 is implemented using other types of memory including, for example, static random-access memory (SRAM), nonvolatile RAM, and the like. According to embodiments, the memory 106 includes an external memory implemented external to the processing units implemented in the processing system 100. The processing system 100 also includes a bus 112 to support communication between entities implemented in the processing system 100, such as the memory 106. Some embodiments of the processing system 100 include other buses, bridges, switches, routers, and the like, which are not shown in FIG. 1 in the interest of clarity.

The techniques described herein are, in different embodiments, employed at accelerated processing unit (APU) 114. APU 114 includes, for example, any of a variety of parallel processors, vector processors, coprocessors, graphics processing units (GPUs), general-purpose GPUs (GPGPUs), non-scalar processors, highly parallel processors, artificial intelligence (AI) processors, inference engines, machine learning processors, other multithreaded processing units, scalar processors, serial processors, or any combination thereof. The APU 114 renders images according to one or more applications 110 (e.g., shader programs) for presentation on a display 120. For example, the APU 114 renders objects (e.g., groups of primitives) according to one or more shader programs to produce values of pixels that are provided to the display 120, which uses the pixel values to display an image that represents the rendered objects. To render the objects, the APU 114 implements a plurality of processor cores 116-1 to 116-N that execute instructions concurrently or in parallel from, for example, one or more applications 110. For example, the APU 114 executes instructions from a shader program, graphics pipeline, or both using a plurality of processor cores 116 to render one or more objects. According to implementations, one or more processor cores 116 each operate as a compute unit including one or more single instruction, multiple data (SIMD) units that perform the same operation on different data sets. Though in the example implementation illustrated in FIG. 1, three processor cores (116-1, 116-2, 116-N) are presented representing an N number of cores, the number of processor cores 116 implemented in the APU 114 is a matter of design choice. As such, in other implementations, the APU 114 can include any number of processor cores 116. Some implementations of the APU 114 are used for general-purpose computing. The APU 114 executes instructions such as program code 108 (e.g., shader code) for one or more applications 110 (e.g., shader programs) stored in the memory 106 and the APU 114 stores information in the memory 106 such as the results of the executed instruction.

Further, to execute one or more instructions from one or more applications 110, each processor core 116 (e.g., compute unit) includes or is otherwise connected to (e.g., is associated with) one or more first-level caches (e.g., top-level cache) L0 122 each configured to store data (e.g., instructions, values, operands) for executing one or more instructions, store data resulting from the execution of one or more instructions, or both. In embodiments, each first-level cache L0 122 is a private cache. That is to say, each first-level cache L0 122 is designated to a respective processor core 116 (e.g., compute unit) and is not shared with a second processor core 116. Though the example implementation illustrated in FIG. 1 presents three first-level caches L0 (122-1, 122-2, 122-N) representing an N number of first-level caches L0 each included in or otherwise connected to a respective processor core 116 (e.g., compute unit), in other embodiments, APU 114 may include any number of first-level caches L0 122 each included in or otherwise connected to a respective processor core 116. According to embodiments, one or more processor cores 116 are communicatively coupled to one or more lower-level caches 124. Lower-level caches 124 includes one or more levels of shared caches (e.g., different-level caches, L1 cache, L2 cache) each configured to store data (e.g., instructions, operands, values) for executing one or more instructions, store data resulting from the execution of one or more instructions, or both. Each shared cache, for example, includes a cache accessible by two or more processor cores 116 of APU 114. In embodiments, lower-level caches 124 and first-level caches L0 122 are arranged in a cache hierarchy arranged by size (e.g., in megabytes (MBs)) with first-level caches L0 122 (e.g., the smallest caches in the hierarchy) forming a first level(e.g., top level) of the cache hierarchy and one or more caches of lower-level caches 124 forming one or more lower levels of the cache hierarchy.

According to embodiments, processor cores 116 (e.g., compute units) use data transferred from memory 106 to a respective first-level cache 122 to perform one or more operations for one or more applications 110. However, to perform instructions for memory-intensive applications 110 (e.g., raytracing applications, machine-learning applications), processor cores 116 require an amount of data that is larger than the storage capacity of a respective first-level cache 122. For such applications 110 (e.g., raytracing applications, machine-learning applications), using a first-level cache 122 to hold the data needed to perform one or more operations leads to cache thrashing where the operations fail to progress due to excessive use of a first-level cache 122, useful data being evicted from a first-level cache 122, or both. To help process instructions for applications 110 requiring large amounts of data (e.g., raytracing applications, machine-learning applications), processing system 100 includes one or more co-compute units within or otherwise coupled to one or more caches in lower-level caches 124. For example, processing system 100 includes one or more co-compute units within or otherwise connected to a third-level cache (e.g., L2). Such co-compute units include, for example, one or more SIMDs, scalar registers, vector registers, or both configured to perform one or more instructions of one or more applications 110. In embodiments, each co-compute unit within or otherwise connected to a cache of lower-level caches 124 is associated with and communicatively coupled to a respective processor core 116 (e.g., compute unit) and is configured to perform at least a portion of one or more operations on behalf of (e.g., for) the respective processor core 116. To perform one or more operations, each co-compute unit is configured to use at least a portion of one or more caches of lower-level caches 124 (e.g., different-level caches). For example, each co-compute unit is configured to use at least a portion of the cache in which the co-compute unit is within or otherwise connected. In response to performing one or more operations, each co-compute unit is configured to provide one or more results of the operations (e.g., data resulting from the operations) to a respective processor core 116 (e.g., compute unit), make one or more results of the operations available (e.g., in a data buffer) to a respective processor core 116, or both. By using the co-compute units to perform one or more operations on behalf of one or more processing cores 116, the likelihood of cache thrashing is reduced as the caches of lower-level caches 124 are large enough to store the data needed to perform operations for applications 110 such as raytracing applications or machine-learning applications. Additionally, the amount of data moving between first-level caches L0 122 and caches of lower-level caches 124 is reduced, improving the processing speed and lowering the energy required by processing system 100 when performing the operations for such applications 110.

The processing system 100 also includes a central processing unit (CPU) 102 that is connected to the bus 112 and therefore communicates with the APU 114 and the memory 106 via the bus 112. The CPU 102 implements a plurality of processor cores 104-1 to 104-N that execute instructions concurrently or in parallel. In embodiments, one or more of the processor cores 104 each operate as one or more compute units (e.g., SIMD units) that perform the same operation on different data sets. Though in the example embodiment illustrated in FIG. 1, three cores (104-1, 104-2, 104-M) are presented representing an M number of cores, the number of processor cores 104 implemented in the CPU 102 is a matter of design choice. As such, in other embodiments, the CPU 102 can include any number of cores 104. In some embodiments, the CPU 102 and APU 114 have an equal number of processor cores 104, 116 while in other embodiments, the CPU 102 and APU 114 have a different number of processor cores 104, 116. The processor cores 104 execute instructions such as program code 108 stored in the memory 106 and the CPU 102 stores information in the memory 106 such as the results of the executed instructions. The CPU 102 is also able to initiate graphics processing by issuing draw calls to the APU 114. In embodiments, the CPU 102 implements multiple processor cores (not shown in FIG. 1 in the interest of clarity) that execute instructions concurrently or in parallel.

An input/output (I/O) engine 118 includes hardware and software to handle input or output operations associated with the display 120, as well as other elements of the processing system 100 such as keyboards, mice, printers, external disks, and the like. The I/O engine 118 is coupled to the bus 112 so that the I/O engine 118 communicates with the memory 106, the APU 114, or the CPU 102.

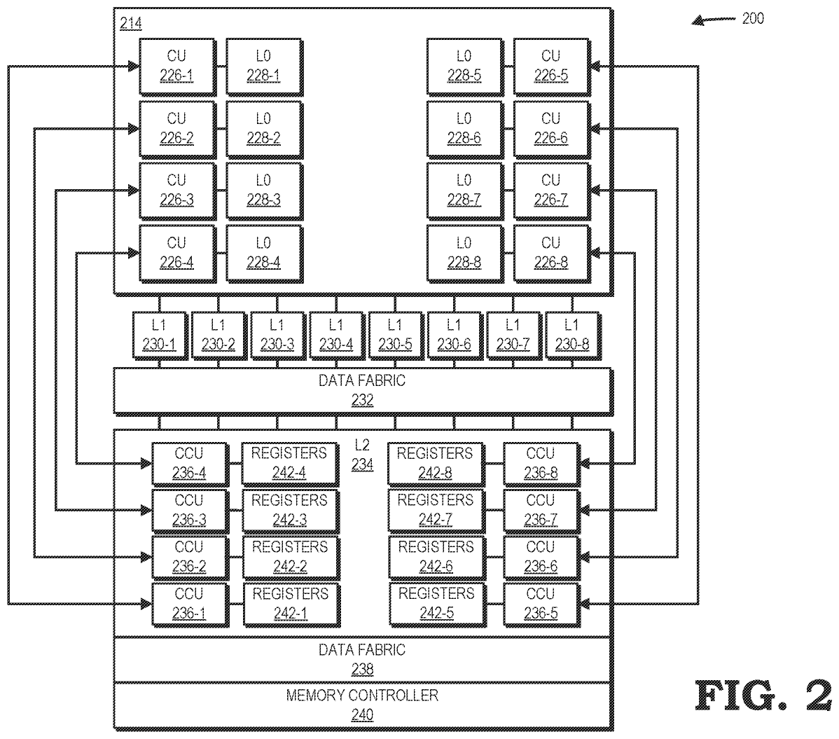

Referring now to FIG. 2, an example architecture 200 of processing system using co-compute units within a lower-level cache is presented. Example architecture 200 includes APU 214, similar to or the same as APU 114, including or otherwise connected to first-level caches L0 228, second-level caches L1 230, and third-level cache L2 234. In embodiments, first-level caches L0 228, second-level caches 230, and third-level cache 234 are in a cache hierarchy arranged by size (e.g., in MBs) with first-level caches L0 228 (e.g., the smallest caches) being at a first level (e.g., top level) of the cache hierarchy and third-level cache L2 234 being at a third level (e.g., bottom level) of the cache hierarchy. According to embodiments, second-level caches L1 230 are included in or otherwise connected to APU 214 (e.g., including first-level caches L0 228) and are communicatively coupled to second-level cache L2 234 by a first data fabric 232. Additionally, second-level cache L2 234 is communicatively coupled to memory controller 240 by a second data fabric 238. In some embodiments, first and second data fabrics 232, 238 are a same data fabric while in other embodiments, first and second data fabrics 232, 238 are distinct data fabrics. Memory controller 240 includes hardware-based circuitry, software-based circuitry, or both configured to transfer data from memory 106 to one or more of first level-caches L0 228, second-level caches L1 230, third-level cache L2 234, or any combination thereof, transfer data from one or more of first level-caches L0 228, second-level caches L1 230, third-level cache L2 234, or any combination thereof to memory 106, or both. Though the example architecture 200 presented in FIG. 2 presents eight first-level caches L1 (230-1, 230-2, 230-3, 230-4, 230-5, 230-6, 230-7, 230-8) included in or otherwise connected to APU 214, in other embodiments, any number of first-level caches L1 230 may be included in or otherwise coupled to APU 214.

According to embodiments, APU 214 is configured to perform one or more operations for one or more applications 110. For example, APU 214 is configured to perform one or more operations for a raytracing application, machine-learning application, or both. To perform these operations, APU 214 includes one or more compute units 226, similar to or the same as processor cores 116. Each compute unit 226 includes, for example, one or more SIMDs, arithmetic logic units (ALU), vector registers, scalar registers, or any combination thereof configured to perform one or more operations for an application 110. Though the example architecture 200 presented in FIG. 2 presents APU 214 having eight compute units (226-1, 226-2, 226-3, 226-4, 226-5, 226-6, 226-7, 226-8), in other embodiments, APU 214 can include any number of compute units 226. Additionally, to perform these operations, each compute unit 226 is associated with a respective first-level cache L0 228. For example, each compute unit 226 includes or is otherwise connected to a respective first-level cache L0 228 (e.g., private first-level cache), similar to or the same as first-level caches L0 122. For example, each compute unit 226 uses data (e.g., instructions, values, operands) stored in a respective first-level cache L0 to perform one or more operations. Such data in first-level caches L0 122 is transferred, for example, from one or more lower-level caches (e.g., second-level cache L1 230, third-level cache L2), memory 106, or both. For example, data is transferred from memory 106 to a first-level cache L0 via memory controller 240. Though the example architecture 200 presented in FIG. 2 presents APU 214 having eight first-level caches L0 (228-1, 228-2, 228-3, 228-4, 228-5, 228-6, 228-7, 228-8) each included in or otherwise coupled to a respective compute unit 226, in other embodiments, APU 214 may have any number of first-level caches L0 228 each included in or otherwise coupled to a respective compute unit 226.

However, to perform operations for one or more memory-intensive applications 110, for example, raytracing applications, machine-learning applications, or both, one or more compute units 226 require an amount of data that is larger than the storage-capacity of a respective first-level cache L0 228. That is to say, first-level caches L0 228 are too small to store the data necessary for, aiding in, or helpful for performing one or more operations for memory-intensive applications 110. Because first-level caches L0 228 are too small to store the data necessary for, aiding in, or helpful for performing one or more of these operations, cache thrashing occurs where these operations fail to progress due to excessive use of a first-level cache L0 228, useful data being evicted from a first-level cache L0 228, or both. To help prevent such cache thrashing, example architecture 200 includes one or more co-compute units (CCU) 236 within or otherwise connected to third-level cache L2 234. Though the example architecture 200 presented in FIG. 2 shows third-level cache L2 234 including eight CCUs (236-1, 236-2, 236-3, 236-4, 236-5, 236-6, 236-7, 236-8), in other embodiments, third-level cache L2 234 may include or otherwise be connected to any number of CCUs 236. Each CCU 236, for example, is configured to perform a portion of the functions of a compute unit 226. That is to say, each CCU 236 is configured to perform some of the functions of a compute unit 226 but lacks the full functionality of a compute unit 226. For example, a CCU 236 is configured to perform one or more add math operations but is not configured to perform one or more transcendental math operations a compute unit 226 is configured to perform. To perform such functions, each CCU 236 includes, for example, one or more SIMDs configured to perform one or more operations of one or more applications 110. As an example, each CCU 236 includes one or more SIMDS each configured to support vector memory access, scalar memory access, add math operations, multiply math operations, or any combination thereof, in order to perform one or more operations of one or more applications 110.

For performing these operations, each CCU 236 is configured to use data (e.g., instructions, values, operands) stored in third-level cache L2 234. For example, to execute one or more operations, each CCU 236 is configured to establish one or more registers 242 within third-level cache L2 234. Such registers 242 include, for example, respective vector registers, respective scalar registers, or both configured to store data (e.g., operands, results) used by a CCU 236 to perform one or more operations. Such registers 242, for example, have a fixed size (e.g., have a predetermined size), have a dynamic size, or both. According to embodiments, each CCU 236 is configured to establish a register 242 in third-level cache L2 234 representing both a vector register and scalar register for the CCU 236, also referred to herein as a uniform register. In embodiments, one or more CCUs 236 are configured to establish one or more registers 242 as local registers. Such local registers, for example, are not flushed from third-level cache L2 234 to memory 106. For example, one or more vector registers, scalar register, uniform registers, or any combination thereof established by a CCU 236 are local registers. Additionally, one or more CCUs 236 are configured to establish one or more registers 242 as non-local registers. Such non-local registers, for example, are flushed from third-level cache L2 234 to memory 106. For example, one or more scalar registers established by a CCU 236 are non-local registers. Though the example architecture 200 of FIG. 2 illustrates CCUs 236 establishing eight registers (242-1, 242-2, 242-3, 242-4, 242-5, 242-6, 242-7, 242-8) in third-level cache L2 234, in other embodiments CCUs 236 may establish any number of registers 242 in third-level cache L2 234.

In example architecture 200, each CCU 236 is communicatively coupled to a respective compute unit 226 of APU 214. In embodiments, each CCU 236 is configured to perform one or more operations on behalf of a respective compute unit 226 (e.g., a compute unit 226 communicatively coupled to CCU 236). As an example, a compute unit 226 receiving instructions to perform one or more operations for a memory-intensive application 110 (e.g., raytracing application, machine-learning application) is configured to send one or more instructions to perform one or more operations of the memory-intensive applications 110, one or more parameters for performing the operations, or both to a respective CCU (e.g., respective co-compute unit) 236. Such parameters include data defining one or more values necessary for, aiding in, or helpful for performing one or more operations, for example, required register files for an operation, memory requirements for an operation (e.g., the size of the data needed to perform the operation), default values for variables, formats for values (e.g., floating point format, integral format, pointer format), scalar parameters, vector parameters, or any combination thereof. In response to receiving the instructions to perform one or more operations of the memory-intensive application 110, parameters for performing the operations, or both, the CCU 236 is configured to perform the operations of the memory-intensive application 110 on behalf of the associated compute unit 226 based on the received parameters, third-level cache 234, or both. For example, to perform operations of the memory-intensive application 110 on behalf of the associated compute unit 226, the CCU 236 establishes one or more registers 242 (e.g., vector registers, scalar registers, uniform registers) in third-level cache 234, launches one or more waves to perform the operations, uses one or more received parameters to perform the operations, or any combination thereof. The CCU 236 then sends the results (e.g., data resulting from the performance of the operations) to the associated compute unit 226, makes the results available (e.g., in a data buffer) to the associated compute unit 226, or both. As another example, a serial peripheral interface (SPI) (not illustrated for clarity), by, for example, another processor, provides instructions to a compute unit 226 to send parameters (e.g., required register files for an operation, memory requirements for an operation, default values for variables, formats for values scalar parameters, vector parameters) relating to one or more operations of one or more memory-intensive applications 110 to a respective CCU 236 (e.g., the CCU communicatively coupled to the compute unit 226). Additionally, the SPI, by, for example, another processor, provides instructions to the respective CCU 236 to perform one or more operations for the memory-intensive applications 110 based on the received parameters from the compute unit 226. The CCU 236 then performs the operations based on the received parameters and using third-level cache L2 234 and provides the results (e.g., data resulting from performing the operations) to the compute unit 226, makes the results available (e.g., in a data buffer) to the compute unit 226, or both. Because each CCU 236 uses third-level cache L2 234 to perform the operations of memory-intensive applications 110 on behalf of a respective compute unit 226, the likelihood that cache-thrashing occurs is reduced as third-level cache L2 234 is large enough to store the data necessary for, aiding in, or helpful for performing these operations. Additionally, the amount of data moving between first-level caches L0 228, second-level caches 230, third-level cache 234, and memory while these operations are performed is reduced, improving the processing speed and lowering the energy required by processing system 100 when performing the operations for memory-intensive applications 110.

In embodiments, each CCU 236 is configured to dynamically establish one or more registers 242 in response to receiving instructions to perform one or more operations from an associated compute unit 226, an SPI, or both. To dynamically establish one or more registers 242, each CCU 236 is configured to determine a size (e.g., necessary size, minimum size) for one or more registers 242 (e.g., vector registers, scalar registers, uniform registers) based on the operations to be performed (e.g., the operations identified in the instructions to perform one or more operations). For example, based on the operations to be performed, a CCU 236 determines a size (e.g., minimum size) of a vector register, scalar register, uniform register, or any combination thereof necessary for, aiding in, or helpful for performing the operations to be performed. As an example, a CCU 236 determines the minimum size of a uniform register necessary for performing one or more of the operations to be performed. After determining a size (e.g., minimum size) of a vector register, scalar register, uniform register, or any combination thereof necessary for, aiding in, or helpful for performing the operations to be performed, the CCU 236 then establishes a vector register, scalar, register, uniform register, or any combination thereof in third-level cache L2 234 based on the determined size (e.g., establishes a register 242 having a size equal to the determined size). In this way, a CCU 236 dynamically establishes one or more registers 242 based on the needs of the operations of one or more memory-intensive applications 110. As such, the amount of space in third-level cache L2 234 is reduced, improving the cache efficiency of processing system 100.

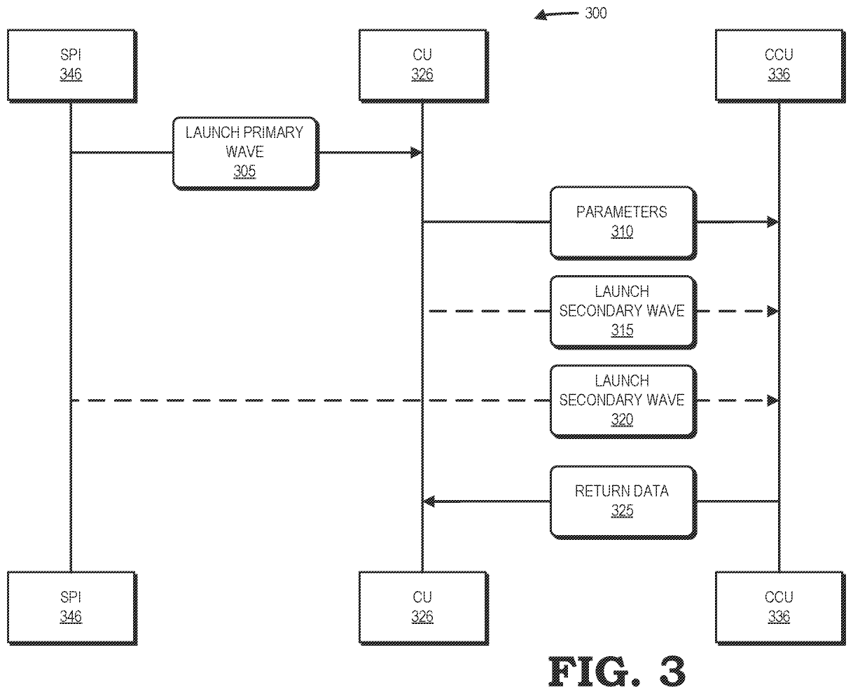

Referring now to FIG. 3, a signal diagram of an example operation 300 for having one or more CCUs performing operations on behalf of a compute unit is presented. In embodiments, an SPI 346 (e.g., by a processor) provides launch primary wave instruction 305 to a CCU 336, similar to or the same as a CCU 236. Launch primary wave instruction 305 includes, for example, data indicating one or more operations to be performed for one or more applications 110 by compute unit 326 by one or more waves of compute unit 326. As an example, launch primary wave instruction 305 indicates one or more operations to be performed for one or more memory-intensive applications 110 (e.g., raytracing applications, machine-learning applications). According to embodiments, launch primary wave instruction 305 further includes data indicating one or more operations to be performed by a respective CCU 336, similar to or the same as CCUs 236 (e.g., a CCU communicatively coupled to compute unit 326). As an example, launch primary wave instruction 305 includes data indicating one or more parameters for one or more operations to be sent to CCU 336, one or more operations to be performed by CCU 336, or both. In response to receiving launch primary wave instruction 305, compute unit is configured to launch a wave (e.g., a primary wave) configured to perform one or more operations indicated in launch primary wave instruction 305, determine one or more parameters indicated in launch primary wave instruction 305, or both. After compute unit 326 has launch the wave (e.g., the primary wave), compute unit 326 is configured to send one or more parameters 310 to CCU 336. Such parameters 310, for example, are values indicated in launch primary wave instruction 305, values determined from performing one or more operations indicated in primary wave instruction 305, or both. For example, such parameters 310 include data defining one or more values necessary for, aiding in, or helpful for performing one or more operations, for example, required register files for an operation, memory requirements for an operation (e.g., the size of the data needed to perform the operation), default values for variables, formats for values (e.g., floating point format, integral format, pointer format), scalar parameters, vector parameters, or any combination thereof.

In some embodiments, after compute unit 326 has sent parameters 310 to CCU 336, compute unit 326 is configured to send a launch secondary wave instruction 315 to CCU 336. Launch secondary wave instruction 315 includes, for example, data indicating one or more operations to be performed by CCU 336. As an example, launch secondary wave instruction 315 includes one or more operations to be performed by CCU 336 on behalf of compute unit 326 for one or more memory-intensive applications 110. In other embodiments, after compute unit 326 has sent parameters 310 to CCU 336, SPI 346, by, for example, a processor, provides launch secondary wave instruction 320 to CCU 336. Launch secondary wave instruction 320, similarly to launch secondary wave instruction 315, includes, for example, data indicating one or more operations to be performed by CCU 336. In response to receiving launch secondary wave instruction 315, launch secondary wave instruction 320, or both, CCU 336 is configured to launch a wave (e.g., secondary wave) to perform one or more operations indicated in launch secondary wave instruction 315, launch secondary wave instruction 320, or both based on, for example, parameters 310 (e.g., using parameters 310 to perform one or more operations). After CCU 336 has launched the wave (e.g., the secondary wave), CCU 336 is configured to send return data 325 to compute unit 326. Return data 325 includes, for example, data resulting from the performance of the operations by the secondary wave. In this way, CCU 336 is configured to perform one or more operations for one or more memory-intensive application 110 on behalf of compute unit 326.

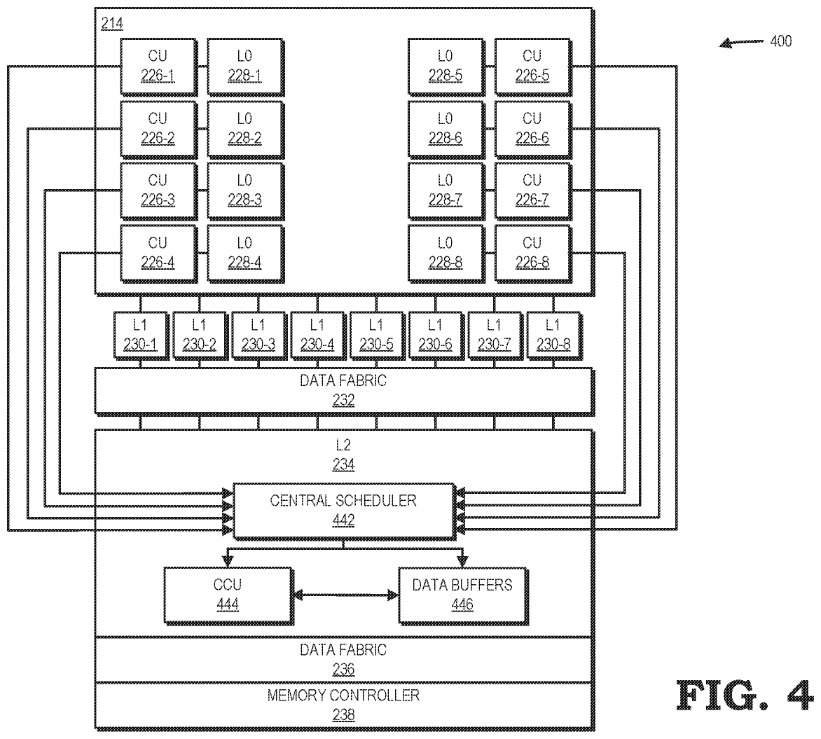

Referring now to FIG. 4, an example architecture 400 of processing system using a virtual co-compute unit within a lower-level cache (e.g., different-level cache) is presented. Similarly to example architecture 200, example architecture 400 includes APU 214, similar to or the same as APU 114, including or otherwise connected to first-level caches L0 228, second-level caches L1 230, and third-level cache L2 234. Further, APU 214 includes one or more compute units 226 each coupled to a respective first-level cache L0 228. In embodiments, example architecture 400 includes each compute unit 226 communicatively coupled to central scheduler 442. Central scheduler 442 includes, for example, hardware-based circuitry, software-based circuitry, or both configured to schedule one or more operations on behalf of one or more compute units 226. To this end, each compute unit 226 is configured to send instructions to central scheduler 442. Such instructions include, for example, one or more operations to be performed for one or more application 110 (e.g., memory-intensive applications), one or more parameters (e.g., required register files for an operation, memory requirements for an operation, default values for variables, formats for values, scalar parameters, vector parameters) for performing one or more operations, data identifying the compute unit 226 issuing the instructions, or any combination thereof. As an example, such instructions include one or more operations to be performed and data (e.g., four bits) identifying the compute unit 226 issuing the instructions.

In response to receiving instructions from one or more compute units 226, central scheduler 442 is configured to schedule the operations indicated in the instructions for performance by CCU 444, similar to CCU 236, 336, included in or otherwise coupled to third-level cache L2 234. CCU 444, for example, includes one or more SIMDs configured to perform one or more operations using third-level cache L2 234. For example, CCU 444 is configured to establish one or more registers (e.g., vector registers, scalar registers, uniform registers), similar to or the same as registers 242, configured to store data necessary for, aiding in, or helpful for performing one or more operations in third-level cache L2 234, or both. According to embodiments, central scheduler 442 is configured to schedule the operations for performance based on, for example, the order in which the instruction indicating the operations were received, a priority of the compute unit 226 issuing the instructions, the type of operations (e.g., vector computation operation, scalar computation operation), a workgroup associated with the operations, or any combination thereof. In response to one or more operations being scheduled for performance, central scheduler 442 provides instructions indicating the operations, one or more parameters to perform the operations, and the compute unit 226 that sent the instructions indicating the operations to CCU 444. In response to receiving the instructions from central scheduler 442, CCU 444 is configured to launch a wave to perform one or more operations indicated in the instructions based on one on more parameters indicated in the instructions and using third-level cache L2 234.

After launching a wave to perform one or more operations indicated in the instructions from central scheduler 442, CCU 444 is configured to store data resulting from the performance of the operations in one or more data buffers 446. In embodiments, CCU 444 is configured to store data resulting from the performance of the operations in one or more data buffers 446 associated with the compute unit 226 that sent instructions indicating the operations to central scheduler 442. That is to say, CCU 444 identifies a compute unit 226 based on instructions received from central scheduler 442 and stores data resulting from the performance of the operations in one or more data buffers 446 associated with the identified compute unit 226. The data resulting from the performance of the operations is then made available to the identified compute unit 226. In this way, a centralized CCU 444 is configured to perform one or more operations for one or more memory-intensive application 110 on behalf of one or more compute units 226. As such, the complexity of CCU 444 is reduced to a single CCU and one or more operations (e.g., vector computations, scalar computations) are performed without moving data to one or more first-level caches L0 228, reducing the amount of data moving between the levels of the caches and improving processing efficiency of processing system 100.

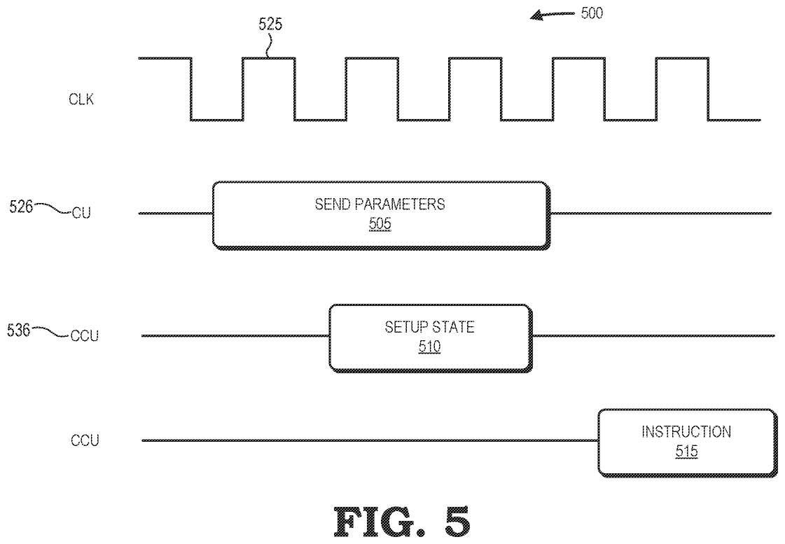

FIG. 5 presents an example timing diagram 500 for performing one or more operations on a CCU on behalf of a compute unit, in accordance with some embodiments. Example timing diagram 500 includes a clock signal 525 including a number of clock cycles each represented by the time between rising edges in clock signal 525. In embodiments, in response to receiving, for example, launch primary wave instruction 305 from SPI 346, compute unit 526, similar to or the same as compute units 226, 326, is configured to send parameters 505, similar to or the same as parameters 310, to CCU 536, similar to or the same as CCUs 236, 336. For example, compute unit 526 is configured to send parameters 505 to CCU 536 that includes one or more parameters used to perform one or more operations on behalf of compute unit 526. In the example timing diagram 500, compute unit 526 is configured to send parameters 505 to CCU 536 in less than four clock cycles. In response to receiving one or more parameters 505, CCU 536 is configured to enter setup state 510. Setup state 510 includes, for example, CCU 536 loading one or more programs to perform one or more operations, setting up one or more registers, similar to or the same as registers 242, in third-level cache L2 234, to perform one or more operations, loading one or more received parameters 505, or any combination thereof. In the example timing diagram 500, CCU 536 takes less than three clock cycles to complete the setup state 510. In embodiments, the clock cycles to complete the setup state 510 are concurrent with the clock cycles during which compute unit 526 sends parameters 505 to CCU 536.

In response to completing setup state 510, CCU 536 launches a secondary wave to perform one or more operations on behalf of compute unit 526. Once the secondary wave is launched, CCU 536 completes a first instruction 515 in the wave. In the example timing diagram 500, CCU 536 is configured to perform the first instruction 515 of the wave in one clock cycle or less. In this way, example timing diagram 500 demonstrates that the number of clock cycles required to launch a secondary wave on CCU 536 is five clock cycles or less. As such, having CCU 536 use third-level cache L2 234 to perform one or more operations on behalf of compute unit 526 only adds five clock cycles or less to the processing overhead. Due to only adding five clock cycles or less to the processing overhead, having CCU 536 use third-level cache L2 234 to perform one or more operations on behalf of compute unit 526 improves processing efficiency by reducing the amount of data moving between the caches, reducing miss latency due to misses in a first-level cache L0, or both.

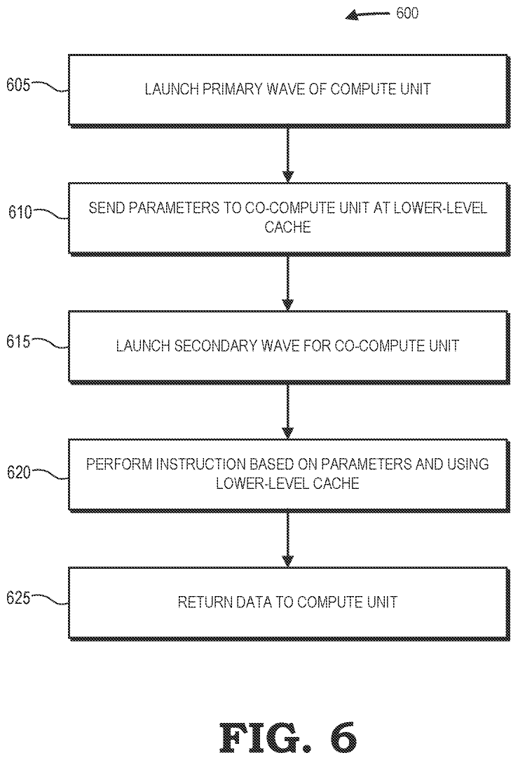

Referring now to FIG. 6, an example method 600 for a CCU in a lower-level cache performing one or more operations on behalf of a compute unit is presented. At step 605 of the method, a compute unit, similar to or the same as compute units 226, 326, 526, received instructions from, for example, an SPI indicating one or more operations to be performed for one or more memory-intensive application 110. Additionally, such instructions indicate one or more parameters, similar to or the same as parameters 310, 505, to be determined, one or more operations to be performed by a CCU, similar to or the same as CCUs 236, 336, 536, or both. In response to receiving the instructions, the compute unit launches a primary wave to perform one or more operations indicated in the instructions. At step 610, the compute unit sends one or more parameters (e.g., required register files for an operation, memory requirements for an operation, default values for variables, formats for values, scalar parameters, vector parameters) to the CCU in a lower-level cache (e.g., third-level cache L2 234). Such parameters, for example, are parameters resulting from the performing of one or more operations in the primary wave, parameters necessary for, aiding in, or helpful for performing one or more operations, or both.

At step 615, the CCU is configured to receive a launch secondary wave instruction from the compute unit, an SPI (e.g., via a processor), or both. Such a secondary wave instruction includes, for example, one or more operations to be performed by the CCU on behalf of the compute unit. In embodiments, the launch secondary wave instruction is received concurrently with one or more parameters from the compute unit. In response to receiving the launch secondary wave instruction, the CCU is configured to establish one or more registers, similar to or the same as registers 242 in the lower-level cache (e.g., third-level cache L2 234) to perform the operations indicated in the launch secondary wave instruction. For example, the CCU establishes one or more fixed-size vector registers, fixed-size scalar registers, fixed-size uniform registers, dynamically-sized vector registers, dynamically-sized scalar registers, dynamically-sized uniform buffers, or any combination thereof, necessary for, aiding in, or helpful for performing the operations indicated in the launch secondary wave instruction. After establishing the registers, the CCU is configured to launch a secondary wave to perform one or more operations indicated in the launch secondary wave instruction. At step 620, the wave of the CCU performs one or more operations indicated in the launch secondary wave instruction based on one or more parameters received from the compute unit and using one or more registers established in the lower-level cache (e.g., third-level cache L2 234). At step 625, data resulting from the performance of more one or more operations indicated in the launch secondary wave instruction are provided to the compute unit, made available to the compute unit (e.g., in a shared buffer), or both.

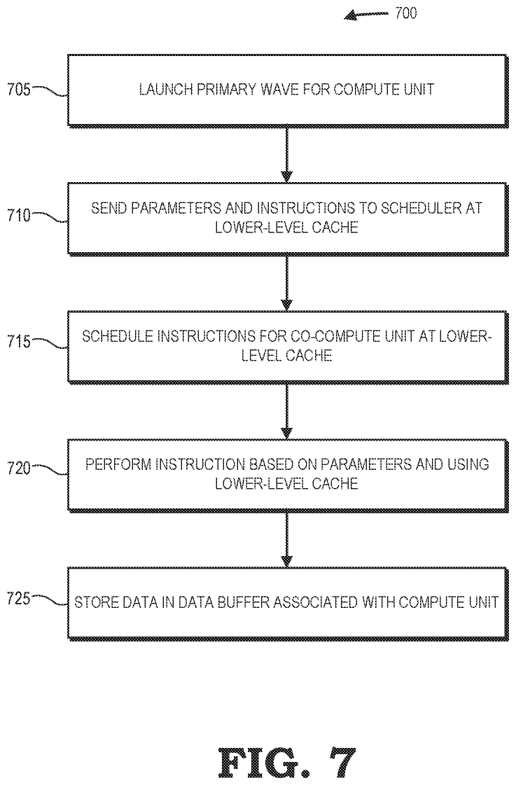

Referring now to FIG. 7, an example method 700 for a virtual CCU in a lower-level cache performing one or more operations on behalf of a compute unit is presented. At step 705 of the method, a compute unit, similar to or the same as compute units 226, 326, 526, receives instructions from, for example, an SPI indicating one or more operations to be performed for one or more memory-intensive applications 110. Additionally, such instructions indicate one or more parameters, similar to or the same as parameters 310, 505, to be determined, one or more operations to be performed by a virtual CCU, similar to or the same as CCU 444, or both. In response to receiving the instructions, the compute unit launches a primary wave to perform one or more operations indicated in the instructions. At step 710, the compute unit sends instructions indicating one or more operations to be performed by a virtual CCU, one or more parameters, and data identifying the compute unit to a central scheduler, similar to or the same as central scheduler 442. Such parameters, for example, are parameters resulting from the performance of one or more operations in the primary wave, parameters necessary for, aiding in, or helpful for performing one or more operations, or both. As an example, the compute unit sends parameters to the central scheduler necessary for performing one or more operations indicated in the instructions sent from the compute unit to the central scheduler. These parameters include, for example, required register files for an operation, memory requirements for an operation, default values for variables, formats for values, scalar parameters, vector parameters, or any combination thereof.

At step 715, the central scheduler schedules the operations indicated in the instructions received from the compute unit for performance by the virtual CCU. The central scheduler schedules the operations based on, for example, the order in which the operations were received, a priority of the compute unit, the type of operations (e.g., vector computation operation, scalar computation operation), a workgroup associated with the operations, or any combination thereof. In response to one or more operations being scheduled for performance by the CCU, the central scheduler sends instructions to the CCU indicating the operations to be performed, parameters necessary for, aiding in, or helpful for performing the operations, and data identifying the compute unit that sent the instructions indicating the operations to the central scheduler. At step 720, in response to receiving the instructions from the central scheduler, the virtual CCU is configured to establish one or more registers, similar to or the same as registers 242 in the lower-level cache (e.g., third-level cache L2 234) to perform the operations indicated in the instructions from the central scheduler. For example, the virtual CCU establishes one or more fixed-size vector registers, fixed-size scalar registers, fixed-size uniform registers, dynamically-sized vector registers, dynamically-sized scalar registers, dynamically-sized uniform buffers, or any combination thereof, necessary for, aiding in, or helpful for performing the operations indicated in the instructions from the centralized scheduler. After establishing the registers, the virtual CCU is configured to launch a wave (e.g., secondary wave) to perform one or more operations indicated in the instructions from the centralized scheduler. The wave of the virtual CCU then performs one or more operations indicated in the instructions from the central scheduler based on one or more parameters indicated in the instructions received from the central scheduler and using one or more registers established in the lower-level cache (e.g., third-level cache L2 234). At step 725, data resulting from the performance of more one or more operations indicated in the instructions from the central scheduler are provided to a data buffer, similar to or the same as data buffers 446, associated with the compute unit. For example, based on the instructions received from the central scheduler, the virtual CCU identifies the compute unit (e.g., the virtual co-compute unit identifies the compute unit based on the instructions received from the central scheduler). The virtual CCU then stores data resulting from the performance of more one or more operations indicated in the instructions from the central scheduler in a data buffer associated with the identified compute unit.

In some embodiments, the apparatus and techniques described above are implemented in a system including one or more integrated circuit (IC) devices (also referred to as integrated circuit packages or microchips), such as the processing system described above with reference to FIGS. 1-7. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
in response to receiving instructions to perform one or more operations, sending, from a compute unit associated with a first cache, a parameter associated with the one or more operations to a co-compute unit in a second cache; and
performing, at the co-compute unit, an operation of the one or more operations based on the parameter and using the second cache.

2. The method of claim 1, wherein the second cache comprises a different-level cache than the first cache.

3. The method of claim 1, further comprising:
sending instructions from the compute unit to the co-compute unit to perform the operation of the one or more operations.

4. The method of claim 1, further comprising:
in response to receiving the parameter, establishing a register in the second cache.

5. The method of claim 4, further comprising:
determining, based on the operation of the one or more operations, a determined size of the register, wherein the register is established based on the determined size.

6. The method of claim 4, wherein the register includes a uniform register.

7. The method of claim 1, further comprising:
sending, from the co-compute unit to the compute unit, data resulting from a performance of the operation of the one or more operations.

8. A processor, including:
one or more compute units each associated with a respective first cache of a plurality of first caches; and
one or more co-compute units in a second cache each coupled to a respective compute unit of the one or more compute units,
wherein each compute unit is configured to, in response to receiving instructions to perform one or more operations, send a parameter associated with the one or more operations to a respective co-compute unit, and
wherein each co-compute unit is configured to perform an operation of the one or more operations based on the parameter and using the second cache.

9. The processor of claim 8, wherein the second cache comprises a different-level cache than each first cache of the plurality of first caches.

10. The processor of claim 8, wherein each compute unit is configured to send instructions to a respective co-compute unit to perform the operation of the one or more operations.

11. The processor of claim 8, wherein each co-compute unit is configured to, in response to receiving the parameter, establish a register in the second cache.

12. The processor of claim 11, wherein each co-compute unit is configured to determine, based on the operation of the one or more operations, a determined size of the register, wherein the register is established based on the determined size.

13. The processor of claim 11, wherein the register includes a uniform register.

14. The processor of claim 8, wherein each co-compute unit is configured to send data resulting from a performance of the operation of the one or more operations to a respective compute unit.

15. A method comprising:
in response to receiving instructions to perform one or more operations, sending, from a compute unit associated with a first cache, a parameter associated with the one or more operations to a scheduler coupled to a compute unit in a second cache;
scheduling, by the scheduler, a performance of an operation of the one or more operations by a co-compute unit; and
performing, by the co-compute unit, the operation of the one or more operations based on the parameter and using the second cache.

16. The method of claim 15, wherein the second cache comprises a different-level cache than the first cache.

17. The method of claim 15, further comprising:
identifying the compute unit based on instructions received from the scheduler.

18. The method of claim 17, further comprising:
storing data resulting from the performing of the operation of the one or more operations in a data buffer associated with the compute unit.

19. The method of claim 15, further comprising:
establishing a register in the second cache, wherein the operation of the one or more operations is performing using the register.

20. The method of claim 19, further comprising:
determining, based on the operation of the one or more operations, a determined size of the register, wherein the register is established based on the determined size.
